(19) United States
(12) Patent Application Publication
(10) Pub. No.: US 2004/0139828 A1
(43) Pub. Date: Jul. 22, 2004

(54) Structure of spanner handle

(76) Inventor: Hsueh Chin Chang, Taichung City (TW)

Correspondence Address: Chang, Hsueh Chin, P.O.Box 63-150, Taichung City, TW

(21) Appl. No.: 10/389,946

(22) Filed: Mar. 18, 2003

(30) Foreign Application Priority Data
Jan. 21, 2003 (TW) 092201225

(51) Int. Cl. B25B 23/16

(52) U.S. Cl. 81/177.9

(57) ABSTRACT

This invention relates to a kind of spanner with an improved handle, comprising a spanner body, a lengthening bar and a positioning set, wherein the lengthening bar is set on one end of the spanner body, and the positioning set is between the spanner body and the lengthening bar. The spanner is used as a common spanner or lengthened for operations in special occasions, and the scope of application is enlarged. The positioning set is used to position the spanner body and the lengthening bar accurately, and the spanner is easy to handle and store.

### BACKGROUND OF THE INVENTION

1. Field of the Invention

The present invention relates to a kind of spanner, and more specifically the improved structure of the spanner handle.

2. Description of the Prior Art

At present, spanners are applied widely in different occasions. The handle of spanner is of certain length, and common spanners are useless in narrow working places, for operators find it difficult to stretch arms in to operate spanners. The handle may simply be lengthened to overcome this defect and helps to solve the above problems, however, it may also result in larger size of spanners, thus enlarged packing size, higher transportation cost and more space occupied.

Therefore, the inventor develops an improved spanner handle through trial manufactures by combining years of experiences in distribution and research & development of manual tools and components.

### SUMMARY OF THE INVENTION

This invention relates to an improved spanner handle, which is lengthened for operations in special locations, and the scope of application is enlarged.

Another objective of the invention is to provide an improved spanner handle, the lengthened part of which draws near to the handle when not in use, thus no extra packing and space are needed, and transportation of the spanner is easy.

Therefore, this invention offers an improved spanner handle, comprising:

A spanner body with a head and a handle, on one end of which is a pivot joint;

A lengthening bar with an interconnecting piece on one end, which is used to connect with the pivot joint on the spanner handle. This lengthening bar draws near to or extend with the spanner body with the pivot joint as the axis;

A positioning set installed between the spanner body and the lengthening bar and used to position the spanner body and lengthening bar at any specific position.

Referring to the preferred embodiment and description of drawings, the above-mentioned objectives, technique applied, means and other advantages of this invention will become more readily appreciated.

### BRIEF DESCRIPTION OF THE DRAWINGS

FIG. 1 is a three-dimensional exploded view of the invention

FIG. 2 is a vertical sectional view of the incised lengthening bar along the long axis of the spanner handle

FIG. 3 is a vertical sectional view of the incised pivot joint and the lengthening bar along the minor axis of the spanner handle

FIG. 4 is a sectional view from another angel of the incised lengthening bar and the pivot joint along the minor axis of the spanner handle

FIG. 5 is a three-dimensional combined sketch map of the close state of lengthening bar and spanner body

FIG. 6 is a three-dimensional combined sketch map of the open state of lengthening bar and spanner body

FIG. 7 is a schematic plan of this invention in narrow operating environment

FIG. 8 is a combined sketch map of the close state of lengthening bar and spanner body in another application

FIG. 9 is a right side view of this invention in another application

FIG. 10 is a vertical sectional view of the incision state of FIG. 8 in another application

FIG. 11 is a plane combined sketch map of the state of keeping certain angle between the lengthening bar and spanner body in another application

FIG. 12 is a three-dimensional combined sketch map of the full open state of lengthening bar and spanner body

### DESCRIPTION OF THE PREFERRED EMBODIMENT

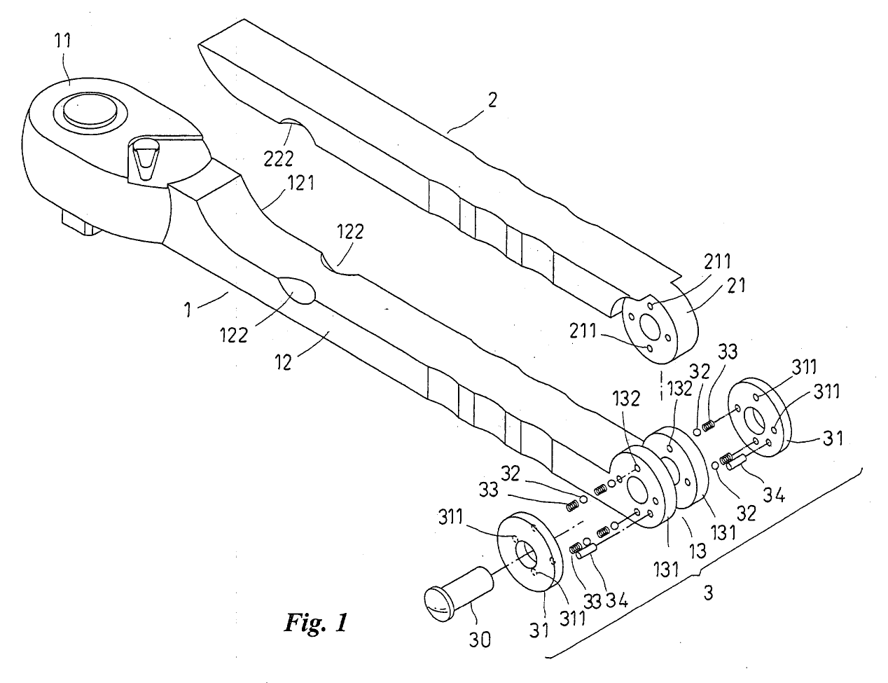

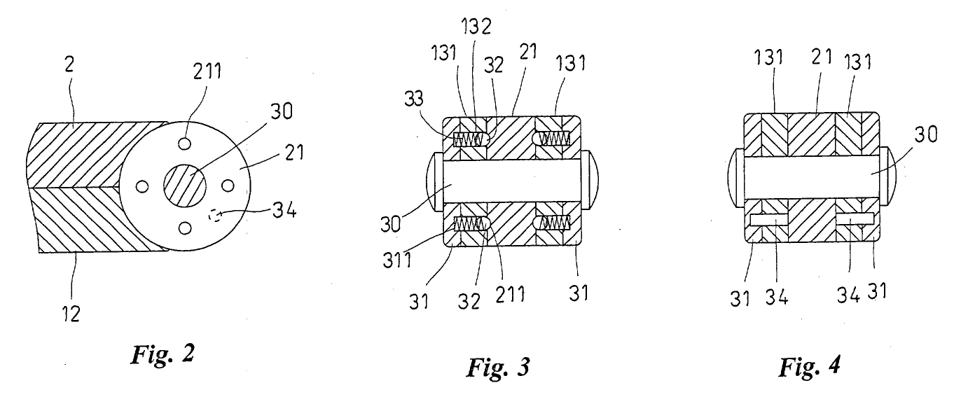

Referring to FIGS. 1-7, in an application of this improved spanner handle, the spanner is composed of a spanner body (1), a lengthening bar (2), and a positioning set (3), wherein:

The spanner body (1) has the same structure as common spanners with a header (11) and a handle (12). On one end of the handle (12), there is a pivot joint (13), which is of a biplate structure (131);

The engthening bar (2) has on one end an interconnecting piece (21) used to be connected with the biplate structure (131) of the pivot joint (13) on the handle (12). In this application, the interconnecting piece (21), of a uniplate structure, is put between the spanner body (1) and the biplate structure (131) and fastened to the pivot joint with the shaft pin rivet (30);

A positioning set (3) is installed between the spanner body (1) and the lengthening bar (2) to locate them on any specific position. In this application, the positioning set (3) is composed of two shaftcups (31), eight steel balls (32), eight elastic cells (33) and two positioning pins (34), where the shaftcups (31) are set on both sides of biplate structure (131) with four locating slots (311) on each side. Corresponding to the locating slot (311), there are push & pull through holes (132) on biplate structure (131) of the pivot joint (13), whose size becomes smaller from outside to inside;

In addition, corresponding to through holes (132) on the biplate structure (131), there are also four seizing slot (211) on each side of the uniplate structure; eight steel balls (32) are put inside through holes (132) of the biplate structure (131); eight elastic cells (33) are also put into through holes (132) of each biplate structure (131) after steel balls (32), one end of which presses against corresponding steel balls (32), thus a part of steel balls (32) is outside of through holes (132), and held in the seizing slot ( 211) of the uniplate structure, while the other end is positioned in locating slot (311) of the shaftcups (31) (referring to FIG. 3);

The positioning pin (34) is between the biplate structure (131) and each shaftcup (31), thus the biplate structure (131) and both shaftcups (31) are connected without being separated from each other (referring to FIG. 4);

Described above are the relations of component positions in this invention and a summary of their structure.

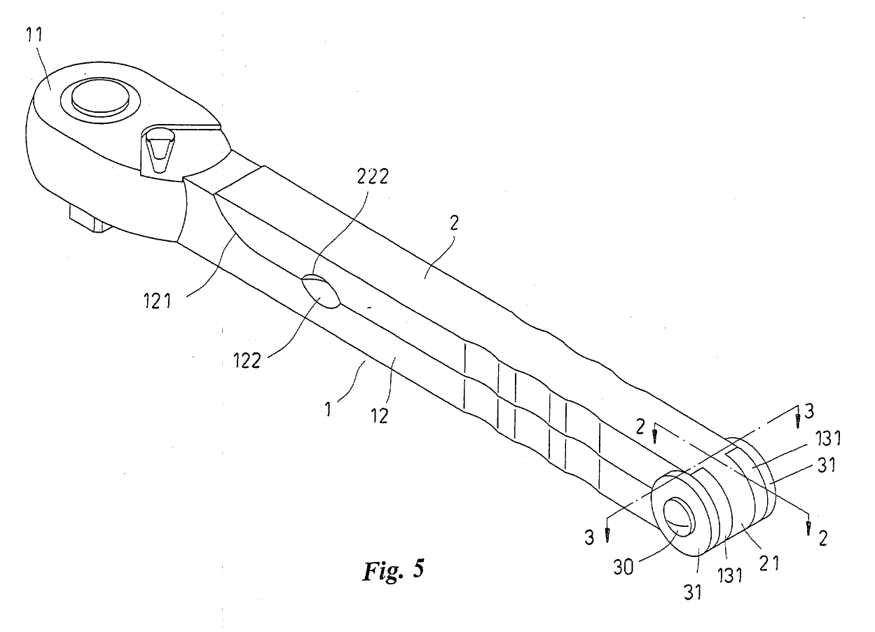

It is noteworthy that there is a notch on handle (12) of the spanner body (1), and a corresponding part is also set on the lengthening bar (2), thus the spanner body (1) and the lengthening bar (2) may merge in one (referring to FIG. 5) without taking up more space.

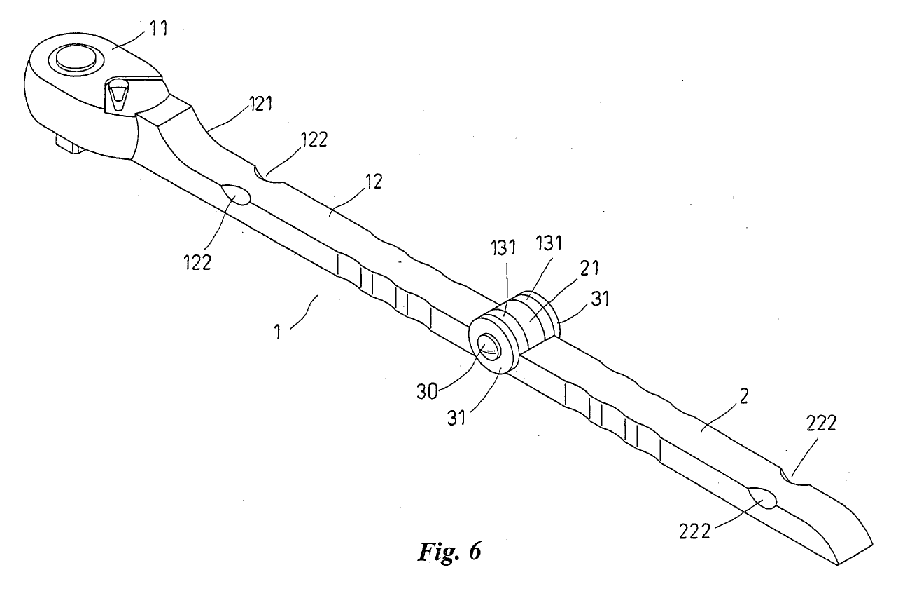

In addition, referring to FIG. 1, FIG. 5 and FIG. 6, there are sulcal notches (122, 222) on corresponding parts of the spanner body (1) and the lengthening bar (2), thus operators could insert fingers into the sulcal notches to open the spanner, referring to FIG. 6, namely the sketch map of the full open state of the spanner body (1) and the lengthening bar (2).

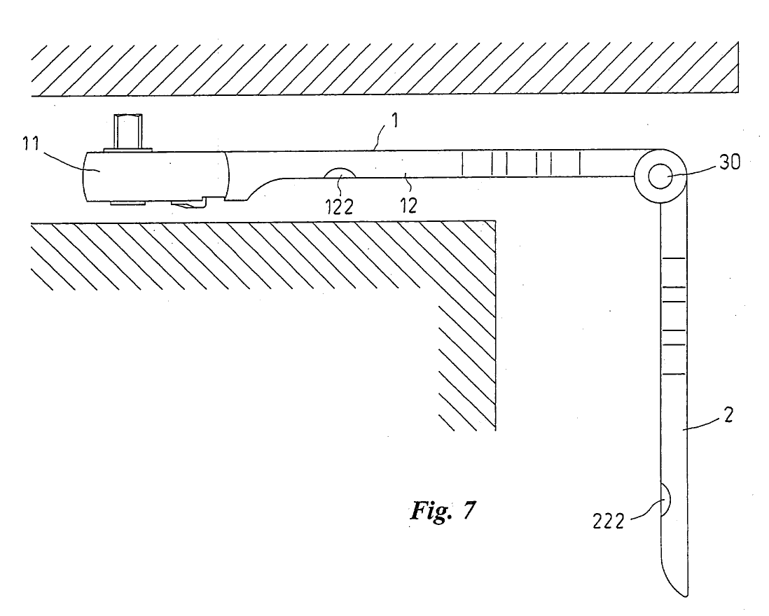

Referring to FIG. 7, the working environment is narrow and common spanners are difficult to operate, while in this invention, hands of operators are not restricted at all by opening the lengthening bar (2) so as to form a right angle with spanner body (1). Operations could be conducted by holding the lengthening bar (2) only, which is really convenient.

It should be mentioned that the lengthening bar (2) is locked when being opened to a scheduled angle, and the locked spanner body (1) and the lengthening bar (2) do not change the locked position before another pulling, therefore, along with the increase of amount of through holes (132) and corresponding seizing slot (211), there are more available angles formed between the lengthening bar (2) and the spanner body (1), and the application range is wider.

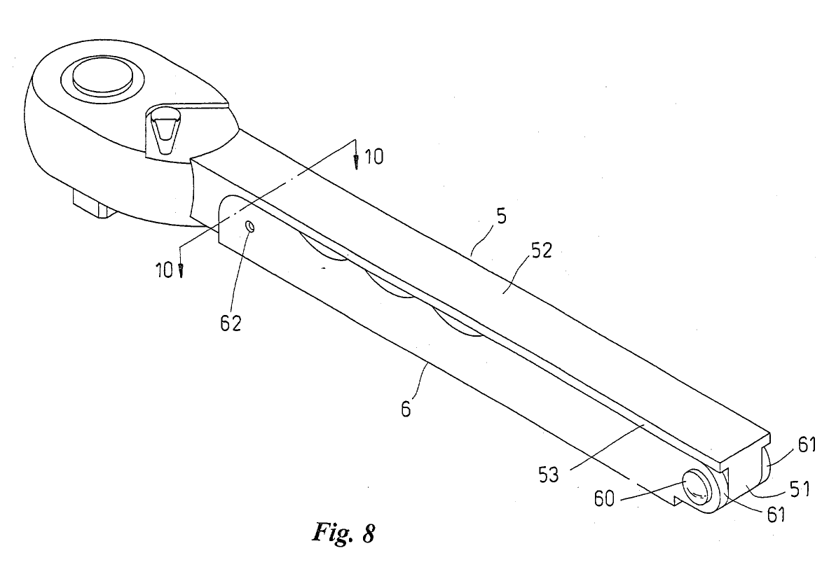

Referring to FIG. 8 to FIG. 12, it is another application of the improved spanner handle, and its operation is almost the same as that in the first case, while the difference is that the pivot joint (51) of the spanner body (5) is of a uniplate structure, and the interconnecting piece (61) of the lengthening bar (6) is of a biplate structure. The uniplate structure is set between the biplate structure, and they are connected in one with a shaft pin (60).

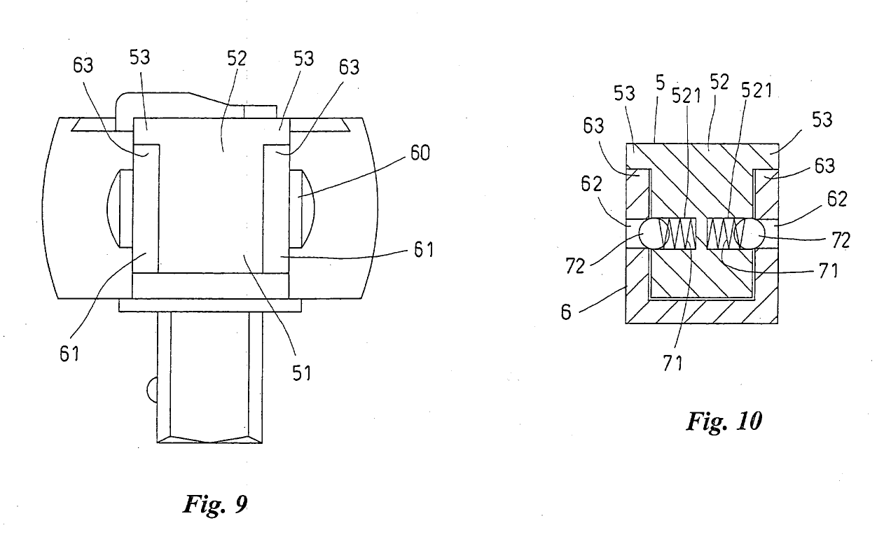

Furthermore, the handle (52) of the spanner body (5) is of a T section structure, while the corresponding part of the lengthening bar (6) is of a η-section structure (referring to FIG. 9 and FIG. 10), thus the spanner body (5) and the lengthening bar (6) could close as one when approaching each other (referring to FIG. 8); when the spanner is being closed, edge of the η-section (63) of the lengthening bar (6) could press against lateral margin of T section of handle (52) of the spanner body (5), thus they form an integrated body;

In addition, totally different from the first application, the positioning set of this application is quite simple, which is between the handle (52) of the spanner body (5) and the lengthening bar (6), referring to FIG. 10, and composed of two elastic cells (71) and two steel balls (72). A locating slot (521) could be set on both sides of handle (52) of the spanner (5), and elastic cells (71) and steel balls (72) are put into each locating slot (521) in order. A part of steel balls (72) is out of each locating slot (521) under the push of elastic cells (71), and there are seizing slots (62) on both sides of the lengthening bar (6) corresponding to locating slot (521) on handle (52) of spanner body (5). Both seizing slots (62) are used to lock the spanner together with steel balls (72), and the spanner is not to be opened unless external force is exerted.

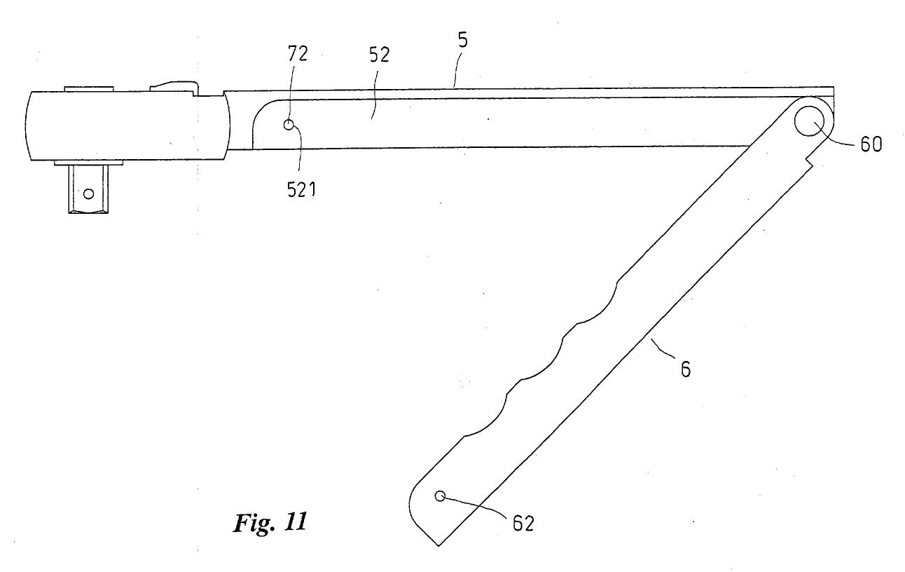

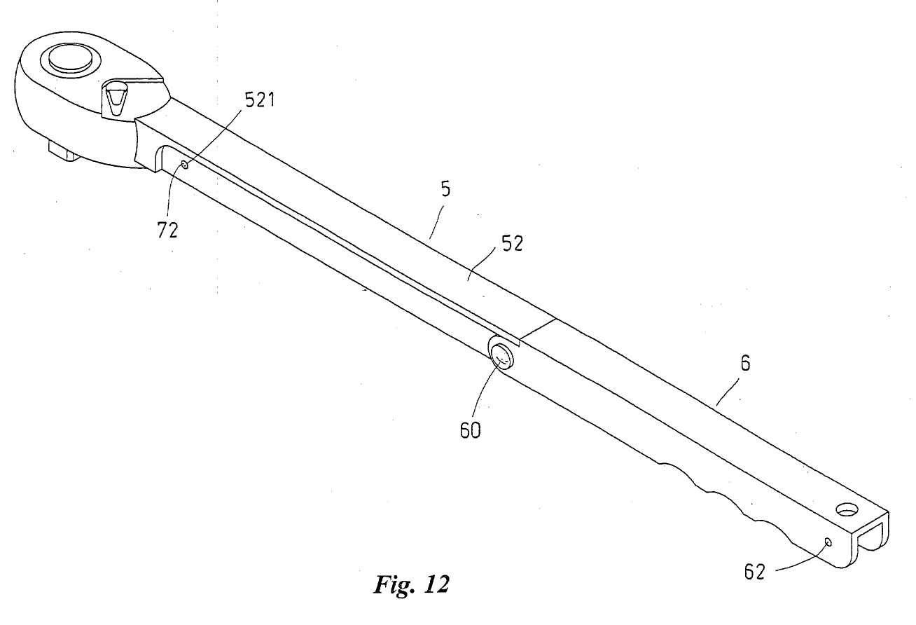

Referring to FIG. 11 and FIG. 12, the lengthening bar (6) is opened to form different angles with the spanner body (5) in the second application, thus applicable in different occasions.

To sum up, this invention relates to a kind of spanner, which is both used as a common spanner and used in special occasions by lengthening the handle of spanner, and the application range is quite wide; apart from this, the spanner handle is adjusted to be close to the spanner body, thus no extra packaging is added, and no extra transport cost or space are needed. We sincerely hope you could examine and approve this advanced invention and grant the patent thereof.

What is claimed is:

1. A spanner with an improved handle, comprising:
A spanner body with a header, a handle and a pivot joint on one end of the handle;
A lengthening bar with an interconnecting piece on one end, which is used to connect the pivot joint on the spanner handle, and merges with the spanner body by rotating around the pivot joint;
A positioning set, which is between the spanner body and the lengthening bar, and which positions the spanner body and lengthening bar at any specific position.

2. An improved structure of spanner handle according to claim 1, wherein the pivot joint of spanner body is of a biplate structure, while the interconnecting piece of lengthening bar is of a uniplate structure; the uniplate structure is inserted into the biplate structure, and both are connected through a shaft pin; while the positioning set is installed between the uniplate structure and biplate structure.

3. An improved structure of spanner handle according to claim 2, wherein the positioning set comprising:
Two shaftcups on both sides of the biplate structure of pivot joint of the spanner body, locating slots corresponding to shaftcups, and push & pull through holes on the biplate structure of the pivot joint corresponding to locating slots, whose size decreases from outside to inside; in addition, corresponding to through holes on the biplate structure, there are seizing slots on both sides of the uniplate structure;
Steel balls in through holes of the biplate structure;
Elastic cells, which are put in through holes of the biplate structure after steel balls, one end of which presses against corresponding steel balls, thus a part of steel balls are outside of through holes, and is locked in seizing slots of the uniplate structure in proper time, while another end of them is positioned inn locating slots on shaftcups;
Two positioning pins between biplate structure of the pivot joint and two shaftcups, thus biplate structure and two shaftcups form an integrated body.

4. An improved structure of spanner handle according to claim 1, wherein there is a notch on the handle of spanner body, and a part corresponding to this notch is set on the lengthening bar, thus the spanner body and the lengthening bar merge in one when approaching each other.

5. An improved structure of spanner handle according to claim 1, wherein there are corresponding sulcal notches on the spanner body and the lengthening bar, thus it is easy to open the spanner.

6. An improved structure of spanner handle according to claim 1, wherein the pivot joint of the spanner body is of a uniplate structure, while the interconnecting piece compartment of the lengthening bar is of a biplate structure; the uniplate structure is inserted into the biplate structure, and a shaft pin is used to connect both; furthermore, the handle of spanner body is of a T section structure, while the corresponding lengthening bar is of a η section structure, thus they merge in one when closing the spanner handle; the positioning set is between the handle of the spanner body and the lengthening bar.

7. An improved structure of spanner handle according to claim 6, wherein the positioning set is composed of two elastic cells and two steel balls; a locating slot is set on both sides of the spanner handle, put elastic cells and steel balls into each locating slot in order, and a part of steel balls is out of locating slots due to push force of elastic cells; then there are seizing slots on both sides of the lengthening bar corresponding to locating slots on the spanner handle, for locking the handle together with steel balls.
